(19) United States
(12) Patent Application Publication
(10) Pub. No.: US 2013/0278158 A1
(43) Pub. Date: Oct. 24, 2013

(54) OLED LIGHTING MODULE

(71) Applicants: Steven KIM, Seoul (KR); Yongduk Kim, Daegu (KR); Byunghoon Kim, Gangwon-do (KR)

(72) Inventors: Steven KIM, Seoul (KR); Yongduk Kim, Daegu (KR); Byunghoon Kim, Gangwon-do (KR)

(73) Assignee: Cheorwon Plasma Research Institute, Gangwon-do (KR)

(21) Appl. No.: 13/611,466

(22) Filed: Sep. 12, 2012

(30) Foreign Application Priority Data
Apr. 23, 2012 (KR) 1020120042136
Apr. 26, 2012 (KR) 1020120030318

(51) Int. Cl. H05B 37/00

(52) U.S. Cl. 315/192; 315/185 R

(57) ABSTRACT

An OLED lighting apparatus includes: an OLED light panel; a first electrode; a second electrode; and at least one resistor connected between the OLED light panel and at least one of the first and second electrodes; first sets of terminals on opposite sides of the module connected to the first and second electrodes; and second sets of terminals on opposite sides of the module, wherein the lighting circuit is connected in series between the first sets of terminals.

This invention claims the benefit of Korean Patent Application No. 10-2012-0042136 filed on Apr. 23, 2012 and Korean Patent Application No. 10-2012-0030318 filed on Mar. 26, 2012, which are hereby incorporated by reference in their entirety.

### BACKGROUND OF THE INVENTION

1. Field of the Invention

This invention relates generally to Organic Light Emitting Diodes (OLED) lighting modules, more precisely, it relates to OLED lighting modules that can be connected to each other in any direction, regardless of the modules orientation. Although embodiments of the invention are suitable for a wide scope of applications, it is particularly suitable for making an OLED lighting design model from OLED lighting module of embodiments of the invention, and then, the model can be disassembled such that another design model can be built by reusing the OLED lighting modules. In addition, the embodiments of the invention is suitable for minimizing electrical and optical characteristics of each OLED lighting module, thereby providing the OLED lighting modules having uniform brightness characteristics.

2. Discussion of the Related Art

The Organic Light Emitting Diode (OLED) has quickly developed in numerous commercial areas in a relatively short period of time, since it was first developed. Previously, the focus of using OLEDs was for displays. Now, now there is also a focus on using the new white OLED in the lighting field.

OLED is desired in the lighting field because of its high efficiency and long lifetime. Because of the need for a new eco-friendly and energy-saved lighting source, white OLED and white Light Emitting Diode (LED) lighting are recognized as the next-generation of promising lighting sources. The white OLED not only has high performance characteristics but also is aesthetically pleasant for viewing purposes. Thus, white OLED can be seen as a more valuable or preferred light source because people are more interested in aesthetically pleasant lighting. For this reason, white OLED lighting can be seen to be the next-generation of lighting after white LED lighting.

LED lighting has many advantages, such as very high intensity, high efficiency and a long lifetime. However, LED lighting has disadvantages, such as the requirement for a large dissipation plate for heat and is inherently a point-type light source that is difficult to diffuse or distribute evenly. The LED is a point-type light source because it is made using a single semiconductor chip. Thus, LED lighting needs additional reflectors and diffusers to create a plate-type lighting effect. In contrast, an OLED lighting source can be made as a flat panel. Because OLED lighting can be made as a plate-type lighting source, it does not need additional reflectors and diffusers to create a plate-type lighting effect.

Furthermore, an OLED light is very thin and light. Thus, OLED lighting enables the making of lighting fixtures with new and innovative design. There are many expert opinions in this industry that OLED lighting will dominate the artistic lighting market.

OLED lighting has flexibility in that an OLED light source can be manufactured as any one or more of point, line and wide plate lighting. For example, OLED lighting can be implemented in an ultra-slim lighting panel having a thickness of 2˜3 mm. In another example, the periphery of a room can be lit with a long lighting line to prevent any light glare in the room. The flexibility of OLED lighting will make a wide variety of types of lighting products for many different uses.

OLEDs are made of eco-friendly organic materials without heavy metals, such as mercury. OLEDs also have high energy efficiency like LEDs. Because OLEDs are eco-friendly high energy efficiency lighting devices, OLEDs are receiving considerable attention as the next-generation of light sources.

Today, the typical OLED lighting panels used as light fixtures have light panels with differing electrical and optical properties. The differences are due to the individual OLED light panels not be manufactured exactly the same or having a range of variation in materials. Even though the same voltage and/or the same current is applied to all of the light panels, all of the panels do not have the same luminance. Therefore, conventional OLED lighting modules made of conventional OLED light panels have visual differences, so when the lighting products were designed and manufactured using several conventional OLED modules, many undesired variations occurred. Further, the conventional OLED modules only went together one way in correspondence with the original design. Once conventional LED lighting modules were manufactured and assembled into finished products, it is very difficult for the conventional OLED lighting modules to be used in other designs.

### SUMMARY OF THE INVENTION

Accordingly, embodiments of the invention are directed to an OLED Lighting Module that substantially obviates one or more of the problems due to limitations and disadvantages of the related art.

An object of embodiments of the invention is to provide an OLED lighting module that can be used for a variety of lighting model designs.

Another object of embodiments of the invention is to provide an OLED lighting modules that can be disassembled, and then a differently designed OLED lighting model is assembled using the OLED lighting modules.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, the OLED lighting module includes: an OLED light panel; a first electrode; a second electrode; and at least one resistor connected between the OLED light panel and at least one of the first and second electrodes; first sets of terminals on opposite sides of the module connected to the first and second electrodes; and second sets of terminals on opposite sides of the module, wherein the lighting circuit is connected in series between the first sets of terminals.

In another aspect, the OLED lighting module having a lighting circuit including: an OLED light panel; a first electrode; a second electrode; and at least one resistor connected between the OLED light panel and at least one of the first and second electrodes; first sets of terminals on opposite sides of the module connected to the first and second electrodes; and second sets of terminals on opposite sides of the module, wherein the OLED lighting circuit is connected in parallel to the first sets of terminals.

To achieve the above objectives, according to embodiments of the invention, an OLED lighting apparatus includes: first and second OLED lighting modules, each of the first and second OLED lighting modules having a first side, a second side opposite to the first side, a third side and a fourth side opposite to the third side; a first lighting circuit in the first OLED lighting module; a second lighting circuit in the second OLED lighting module; a first set of terminals on the first side of the first OLED lighting module; a second set of terminals on the first side of the first OLED lighting module; a third set of terminals on the second side of the second OLED lighting module; a fourth set of terminals on the second side of the second OLED lighting module; a first connector attaching the first and third sets of terminals; and a second connector attaching the second and fourth sets of terminals, wherein the first connector is a first electrical connection between the first and second lighting circuits.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is a diagram showing the configuration of an OLED circuit according to embodiments of the invention.

FIGS. 2a and 2b respectively show two arrangement directions of serially connected OLED lighting modules according to embodiments of the invention.

FIG. 3a shows OLED lighting modules in a serial electrical connection according to an embodiment of the invention.

FIG. 3b shows OLED lighting modules in a parallel electrical connection according to an embodiment of the invention.

FIG. 4a illustrates OLED lighting modules having two groups of serial driven modules interconnected to a third group of modules through parallel connections at long sides according to an embodiment of the invention.

FIG. 4b illustrates OLED lighting modules having two groups of serial driven modules interconnected to a third group of modules through parallel connections at short sides according to an embodiment of the invention.

FIG. 5 illustrates an exemplary radial appearance of a plurality of OLED lighting modules according to an embodiment of the invention.

FIG. 6 illustrates an exemplary radial appearance of a plurality of OLED lighting modules together with dangling OLED lighting modules according to an embodiment of the invention.

FIG. 7 illustrates an exemplary radial appearance of a first plurality of OLED lighting modules driven in parallel together with a second plurality of OLED lighting modules driven in series.

FIG. 8 is a perspective view of a bead LED for attachment to either a serial connectors or parallel connectors in accordance with embodiments of the invention.

FIG. 9 is the circuit diagram to drive the bead LED terminal in accordance with embodiments of the invention.

FIG. 10 is the cross-sectional view of the bead LED terminal in accordance with embodiments of the invention.

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

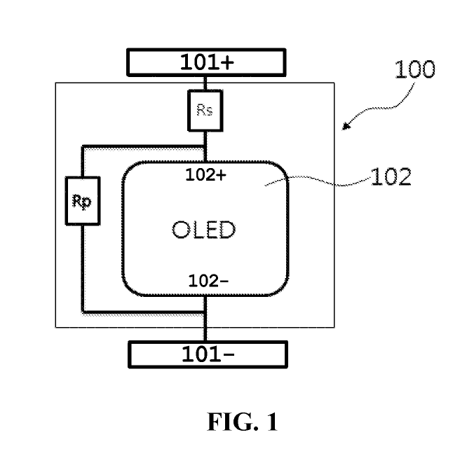

FIG. 1 is a diagram showing the configuration of an OLED circuit according to embodiments of the invention. As shown in FIG. 1, an OLED lighting circuit 100 in embodiments of the invention has an OLED light panel 102, a serial resistor Rs connected between a positive electrode 101+ and the OLED light panel 102 whereas a parallel resistor Rp is connected between the plus 101+ and the minus 101− electrodes of the OLED light panel 102. Although FIG. 1 shows that the serial resistor Rs is connected between the OLED light panel 102 and the positive electrode 101+ of the external power input terminal, the serial resistor Rs can alternatively be connected between the negative electrode 101− of the OLED light panel 102 and the external negative power input 101− of the OLED lighting module. In addition, although FIG. 1 shows the parallel resistor Rp is connected to the negative electrode 101− of the OLED light panel 102 in parallel with the OLED light panel 102, the parallel resistor Rp can alternatively be connected to the positive part of the serial resistor Rs connected to the OLED light panel 102 and to the negative electrode 101− of the OLED light panel 102. The OLED light panel 102 together with the circuitry can be used to form modularly functional individual OLED lighting circuits 100 for use in modules.

Generally, the electrical and optical properties of all of the OLED light panels 102 cannot be identical or equal. In other words, the electrical and optical properties of all the OLED light panels will be different so as to have different luminance in response to either same input voltage or same input current. In embodiments of the invention, the OLED light panels 102 are driven with a same voltage (constant voltage) or a same current (constant current) power using the serial resistor Rs and parallel Rp resistor to minimize brightness deviation throughout a plurality of OLED light panels in a plurality of modules. More specifically, if the serial resistor Rs connected between the OLED light panel 102 and an external power input terminal is appropriately selected according to the electrical and optical properties of a respective OLED light panel such that when the input voltage Vi is supplied to the OLED lighting module 100 to drive the OLED light panel 102, the optimum voltage Vt1 and current It1 to the OLED light panel 102 is supplied and controlled.

The optimized resistance for the serial resistor Rs is determined according to the calculation of Rs=(Vi−Vt1)/It1, where voltage-drop Vi−Vt1 occurs at the serial resistor Rs such that electrically optimized voltage for the OLED light panel is supplied. If another OLED light panel has different electrical and optical properties such as the other voltage Vt2 and current It2 is better, then a different serial resistance Rs'=(Vi−Vt2)/It2 for the serial resistor Rs' is used. The serial resistor Rs can be a variable resistor to enable a customized setting for the OLED light panel of an OLED lighting module. By using this method of selecting the appropriate serial resistor, a plurality of OLED light panels are voltage controlled and optimized with minimal brightness deviation amongst the OLED lighting modules.

The optimized resistance for the parallel resistor Rp can be determined according to the calculation by Rp=Vi/(Ii−It1), where current-dividing Ii−It1 occurs due to the parallel resistor Rs and then the electrically optimized current It1 for the OLED light panel 102 is supplied. If another OLED light panel has different electrical and optical properties such as the optimum current It2 is better, then a different parallel resistance Rp'=Vi/(Ii−It2) is used for the parallel resistor Rp' is used. The parallel resistor Rp can be a variable resistor to enable a customized setting for the OLED light panel of an OLED light module. By using this method of selecting the appropriate parallel resistor, a plurality of OLED light panels are current controlled and optimized with minimal brightness deviation amongst the OLED lighting modules. Embodiments of the invention, using the same external voltage (constant voltage) or the same external current (constant current), such that all of the OLED lighting modules 100 can be preliminarily adjusted to minimize the brightness variation with an optimized serial resistor Rs, parallel resistor Rp or both.

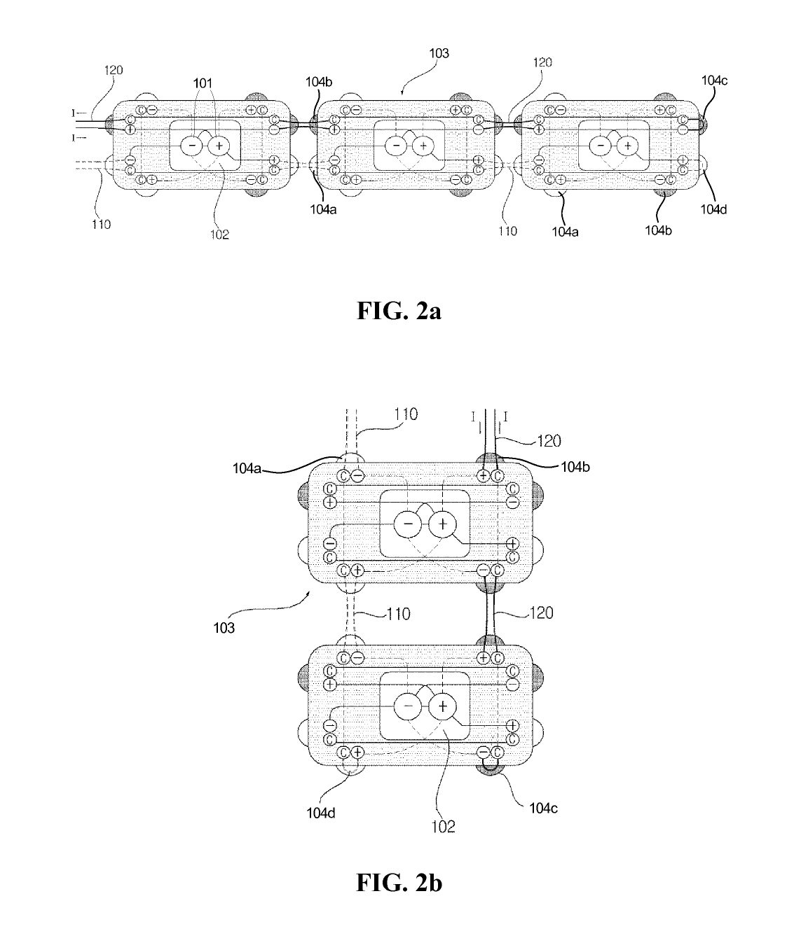

FIGS. 2a and 2b respectively show the two arrangement directions of serial OLED lighting modules according to embodiments of the invention. The serial OLED lighting modules 103 shown in FIGS. 2a and 2b are the same and use the same driving method but are arranged in different directions. Each of the modules 103 has first sets of serial terminals 104a on at least opposite sides of the module 103. In addition, the first sets of serial terminals 104a can also be located on two other opposite sides of the module 100 (shown in FIG. 1). Each of the serial OLED lighting modules 103 have second sets of serial terminals 104b on at least opposite sides of the module 103. In addition, the second sets of serial terminals 104b can also be located on two other opposite sides of the module 103. The light from the OLED lighting module is emitted from the front surface of the module. The back surface of the module opposite to the front surface is reflective or like a mirror. More particularly, the back surface has a high-gloss coating or is metalized using a metal, such as gold and silver.

The serial OLED lighting modules 103 shown in FIGS. 2a and 2b are interconnected in a serial connection through one of the first sets of serial terminals 104a and the second sets of serial terminals 104b using one of the first connectors 110 and the second connectors 120. But only one of the connectors is interconnected electrically. Serial connection of OLED modules includes a plurality of OLED lighting modules connected electrically in serial that can be driven by the constant current driving method. The first connectors 110 shown as dashed lines in FIGS. 2a and 2b are attached to the first sets of serial terminals 104a but are not connected to a power source. The second connectors 120 shown as solid lines in FIGS. 2a and 2b are attached to the second serial terminals 104b and are connected to the power source of current I−. Although both the first connectors 110 and the second connectors 120 are used to attach the serial OLED lighting modules 103 together, only one of the first and second connectors is used for applying a driving current I.

The last OLED lighting module 103 connected in a serially connected OLED lighting modules has third and fourth sets of serial terminals 104c and 104d, which are ‘shorted’ and ‘opened’ into closing or terminating sets of serial terminals, respectively. In other words, the third set 104c is electrically ‘short’, and the fourth set 104d is electrically ‘open’. In FIGS. 2a and 2b, ‘+’ indicates the positive electrode of a set of serial terminals, ‘−’ indicates the negative electrode in another set of serial terminals and ‘C’ is the common electrode in the sets of serial terminals. The common electrodes ‘C’ are commonly connected in the serially connected OLED lighting modules 103 to provide a connection straight through the serial OLED lighting modules 103. Thus, the common electrodes ‘C’ are opposite electrodes in opposing sets of terminals of adjacent modules.

Each of the first and second connectors 110 and 120 has a common electrode ‘C’ and a polar electrode of one of ‘+’ and ‘−’ for serial connection through the first and second sets of serial terminals. In other words, because the serial OLED lighting modules 103 are made for serial connection, only one of the first connectors 110 and second connectors 120 is connected electrically between two adjacent serial OLED lighting modules 103 by connecting to the common electrode and the negative electrode of one of the serial OLED lighting modules 103, and also connecting to the common electrode and the positive electrode of the other OLED lighting modules 103. By this arrangement, the plurality of the serial OLED lighting modules are connected in serial with each other. The serial OLED lighting modules 103 in FIGS. 2a and 2b show only common electrodes ‘C’ across from each other connected, but in the alternative, all of the common electrodes ‘C’ in the same OLED lighting module 103 can be connected to one another.

When power is supplied, the serial OLED lighting modules 103 emit light due to the power supplied through the second connectors 120 connected to the second sets of serial terminals 104b of the OLED lighting modules 103. The first connectors 110 connected to the first sets of serial terminals 104a of the OLED lighting modules 103 can be deactivated internally to prevent the extraneous current flow that could degrade the power current flow. Although the serial OLED lighting modules 103 are attached using the first connectors 110 and the second connectors 120, current flows through only one of the first and second connectors.

Because the serial OLED lighting modules 103 are horizontally and vertically symmetric, the serial OLED lighting modules 103 can be also attached to one another by the first connectors 110 and the second connectors 120 on other sides of the OLED lighting modules 103 on sides at 90 or 270 degrees instead of only sides at 0 and 180 degrees. As shown in FIGS. 2a and 2b, locating the first connectors 110 and the second connectors 120 on four or more sides of the serial OLED lighting modules 103 enable the modules the serial OLED lighting modules 103 to be arranged into different designs.

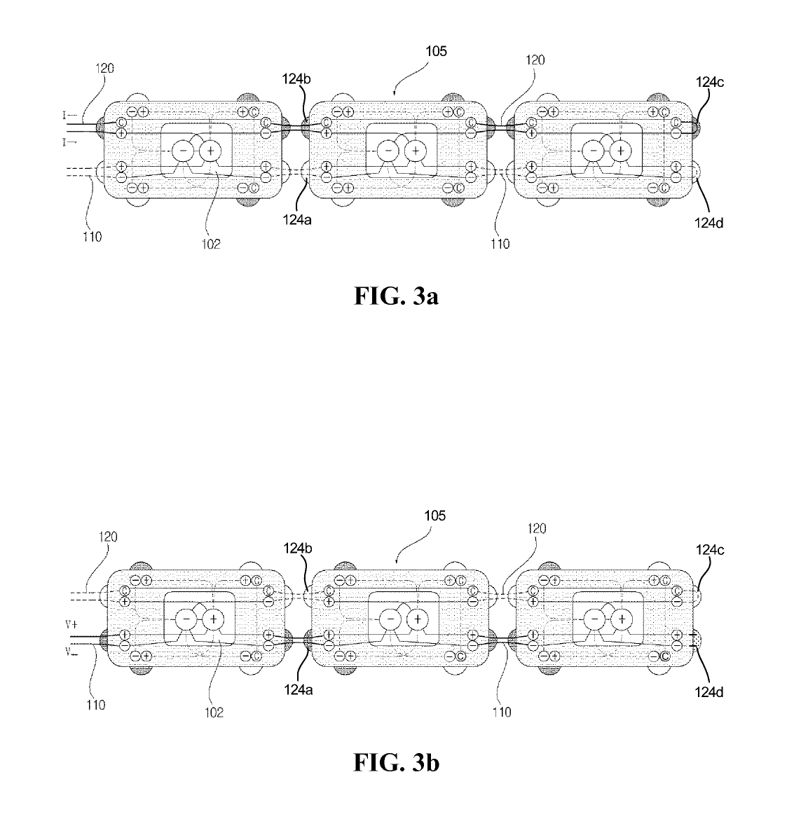

FIG. 3a shows OLED lighting modules in a serial electrical connection according to an embodiment of the invention. FIG. 3b shows OLED lighting modules in a parallel electrical connection according to an embodiment of the invention. FIG. 3a shows OLED lighting modules 105 connected in serial while FIG. 3b shows OLED lighting modules 105 connected in parallel. The OLED lighting modules 105 in FIGS. 3a and 3b have the same configuration of sets of terminals. The first connectors 110 shown as dashed lines in FIG. 3a are attached to the sets of parallel terminals 124a but are not connected to a power source. The second connectors 120 shown as solid lines in FIG. 3a attached to the serial sets of terminals 124b and are connected to the power source of current I. The first connectors 110 shown as dashed lines in FIG. 3b are attached to the sets of parallel terminals 124a and are connected to the power source of voltage V. The second connectors 120 shown as solid lines in FIG. 3b are attached to the sets of serial terminals 124b but are not connected to the power source.

As shown in FIG. 3a, the OLED lighting modules include a plurality of OLED lighting modules 105 electrically connected to each other through the sets of serial terminals 124b by the second connectors 120 in a serial connection in which the last module 105 has an electrically ‘shorted’ set of serial terminals 124c. The OLED lighting modules 105 are attached to each other through both the first connectors 110 and second connectors 120. As shown in FIG. 3a, the current I is applied to the OLED lighting modules 105 only through the second connectors 120. Light is emitted when current I− is supplied through the second connectors 120 to the plurality of serial/parallel OLED lighting modules 105 through the sets of serial terminals 124b. In other words, in the case of the serial connection as shown in FIG. 3a, the power is applied to the OLED lighting modules through the second connectors 120.

As shown in FIG. 3b, the OLED lighting modules include a plurality of OLED lighting modules 105 electrically connected to each other through the sets of parallel terminals 124a by the first connectors 110 in a parallel connection in which the last module 105 has an electrically ‘open’ set of parallel terminals 124d. The OLED lighting modules 105 are attached to each other through both the first connectors 110 and second connectors 120. As shown in FIG. 3b, the voltage V is applied to the OLED lighting modules 105 only through the first connectors 110. Light is emitted when voltage V is supplied through the first connectors 110 to the plurality of OLED lighting modules 105 through the sets of parallel terminals 124a. In other words, in the case of the parallel connection, as shown in FIG. 3b, the power is applied to the OLED lighting modules through the first connectors 110.

Because the OLED lighting modules 105 are horizontally and vertically symmetric, the OLED lighting modules 105 can be also attached to one another by the first connectors 110 and the second connectors 120 on other sides of the OLED lighting modules 105 on sides at 90 or 270 degrees instead of only sides at 0 and 180 degrees. As shown in FIGS. 3a and 3b, locating the first connectors 110 and the second connectors 120 on two or more sides of the serial/parallel OLED lighting modules 103 enable the modules the OLED lighting modules 105 to be arranged into different designs using either serial or parallel connections.

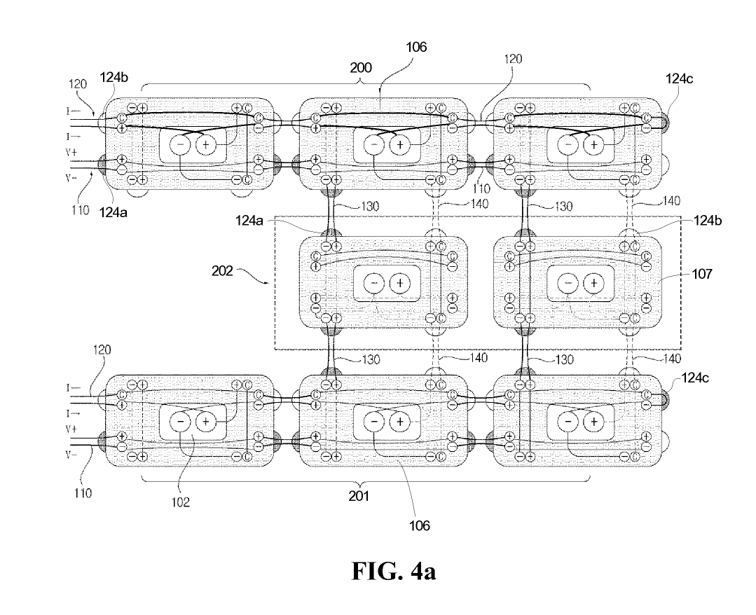

FIG. 4a illustrates OLED lighting modules having two groups of serial driven modules interconnected to a third group of modules through parallel connections at long sides according to an embodiment of the invention. As shown in FIG. 4a, a first group 200 and a second group 201 of the OLED lighting modules 106 are serial modules with parallel pass through (PPT). The sets of serial terminals 124b of a serial/PPT OLED lighting modules 106 drives the OLED of the module while the parallel terminals of the serial/PPT OLED lighting modules 106 are just interconnected. The serial/PPT OLED lighting modules 106 are arranged in the same direction as the long-axis direction of the modules. More specifically, the sets of parallel terminals 124a and sets of serial terminals 124b at the short sides of serial/PPT OLED lighting modules 106 are used for attaching the modules while the sets of serial terminals 124b are also used for driving the modules. More specifically, the first connectors 110 are attached to the serial/PPT OLED lighting modules 106 within the first group 200 and within the second group 201 while the second connectors 120 are both attached and connected in serial with the serial/PPT OLED lighting modules 106 within the first group 200 and within the second group 201. As shown in FIG. 4a, the serial/PPT OLED lighting modules 106 of the first group 200 and the second group 201 are driven in serial by the constant current method through the second connectors 120.

The third group 202 of the OLED lighting modules 107 are parallel modules with serial pass through (SPT). The sets of parallel terminals 124a of a parallel/SPT OLED lighting modules 107 drives the OLED of the module while the sets of serial terminals 124b within the parallel/SPT OLED lighting modules 107 are just interconnected. The parallel/SPT OLED lighting modules 107 are arranged in the same direction as the short-axis direction of the modules such that the sets of parallel terminals 124a and sets of serial terminals 124b at the long sides of the parallel/SPT OLED lighting modules 107 are used for attaching the modules while the sets of parallel terminals 124a are used for driving the modules. The third connectors 130 attached and connected in parallel with the parallel/SPT OLED lighting modules 107 of the third group to adjacent serial/PPT OLED lighting modules 106 of the first group 200 and the second group 201. In addition, the fourth connectors 140 are also attached with the parallel/SPT OLED lighting modules 107 of the third group 202 to adjacent serial/PPT OLED lighting modules 106 of the first group 200 and to adjacent serial/PPT OLED lighting modules 106 of the second group 201. As shown in FIG. 4a, the parallel/SPT OLED lighting modules 107 of the third group 202 are driven in parallel by the constant voltage method through the third connectors 130 and the first connectors 110.

Each of the serial/PPT OLED lighting modules 106 of the first group 200 has the same configuration of sets of parallel terminals 124a and sets of serial terminals 124b, except for the terminating serial terminal 124c of one of the sets of serial terminals 124b. One of the serial serial/PPT OLED lighting modules 106 of the second group 201 only has the sets of parallel terminals 124a and the sets of serial terminals 124b on opposite short sides while the rest of the serial/PPT OLED lighting modules 106 of the second group 201 also have the sets of parallel terminals 124a and the sets of serial terminals 124b on a long side. The parallel/SPT OLED lighting modules 107 of the third group 202 only has the sets of parallel terminals 124a and the sets of serial terminals 124b on opposite long sides.

FIG. 4b illustrates OLED lighting modules having two groups of serial driven modules interconnected to a third group of modules through parallel connections at short sides according to an embodiment of the invention. As shown in FIG. 4b, a first group 300 and a second group 301 of the OLED lighting modules 108 are serial modules with parallel pass through (PPT). The serial/PPT OLED lighting modules 108 are arranged in the same direction as the short-axis direction of the modules such that the sets of parallel terminals 124a and the sets of serial terminals 124b at the long sides of the serial/PPT OLED lighting modules 108 are used for attaching the modules while the sets of serial terminals 124b are used for driving the modules. More specifically, the first connectors 110 are attached with the serial/PPT OLED lighting modules 108 within the first group 300 and within the second group 301 while the second connectors 120 are both attached and connected in serial with the serial/PPT OLED lighting modules 108 within the first group 300 and within the second group 301. As shown in FIG. 4b, the serial/PPT OLED lighting modules 108 of the first group 300 and second group 301 are driven in serial by the constant current method through the second connectors 120.

The third group 302 of OLED lighting modules 109 is parallel modules with serial pass through (SPT). The sets of parallel terminals 124a of a parallel/SPT OLED lighting modules 109 drives the OLED of the module while the sets of serial terminals 124b within the parallel/SPT OLED lighting modules 109 are just interconnected. The third group 302 of a parallel/SPT OLED lighting modules 109 are arranged in the same direction as the long-axis direction of the modules such that the sets of parallel terminals 124a and the sets of serial terminals 124b at the long sides of the a parallel/SPT OLED lighting modules 109 are used for attaching the modules while the sets of parallel terminals 124a are used for driving the modules. The third connectors 130 are attached and connected in parallel with the parallel/SPT OLED lighting modules 109 of the third group to adjacent serial/PPT OLED lighting modules 108 of the first group 300 and the second group 301. In addition, the fourth connectors 140 are also attached with the parallel/SPT OLED lighting modules 109 of the third group 302 to adjacent serial/PPT OLED lighting modules 108 of the first group 300 and the second group 301. As shown in FIG. 4b, the parallel/SPT OLED lighting modules 109 of the third group 302 are driven in parallel by the constant voltage method through the third connectors 130 and the first connectors 110.

One of the serial/PPT OLED lighting modules 108 in each of the first group 300 and the second group 301 only has the sets of parallel terminals 124a and the sets of serial terminals 124b on opposite long sides while the rest of the serial/PPT OLED lighting modules 108 of the first group 300 and the second group 301 also have the sets of parallel terminals 124a and the sets of serial terminals 124b on a short side. The parallel/SPT OLED lighting modules 109 of the third group 302 can have the sets of parallel terminals 124a and the sets of serial terminals 124b on opposite short sides.

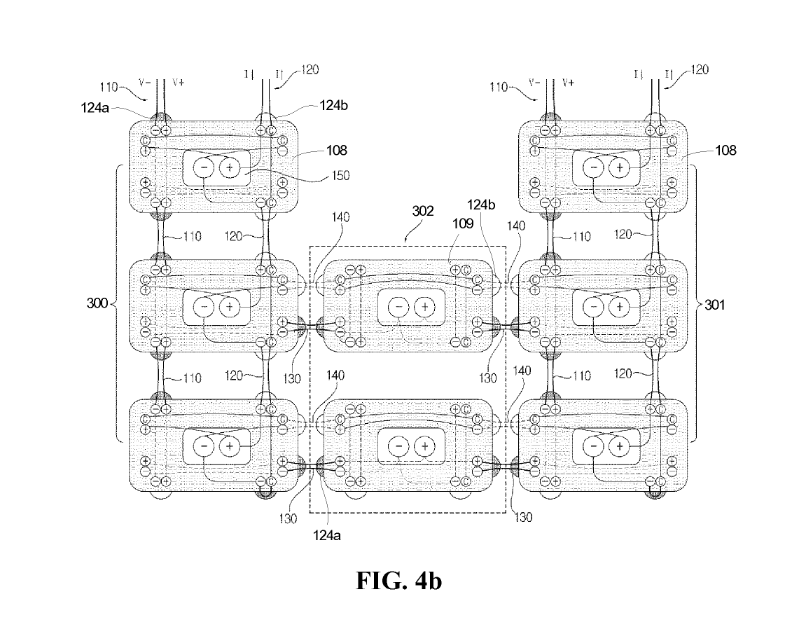

FIG. 5 illustrates an exemplary radial appearance of a plurality of OLED lighting modules according to an embodiment of the invention. As shown in FIG. 5, the OLED lighting apparatus 400 in accordance with embodiments of the invention can have OLED modules 401 arranged to spread out radially from a central part 402 that provides power. More specifically, the OLED modules 401 can be in radial bands 403, 404, 405 and 406 that become larger in circumference away from the central part. The OLED modules 401 in each of the radial bands 403, 404, 405 and 406 is statically held in position within a radial band by first rigid connectors 440 and second rigid connectors 450. The radial bands 403, 404, 405 and 406 are suspended in position by first flexible connectors 441 and second flexible connectors 451. The OLED modules 401 are interconnected by one or more the first rigid connectors 440, the second rigid connectors 450, the first flexible connectors 441 and the second flexible connectors 451. The OLED modules 401 can all be driven in parallel through at least one of the first and second flexible connectors 441 and 451 along the spoke like attachment 420 of OLED modules 401 from the central part 402.

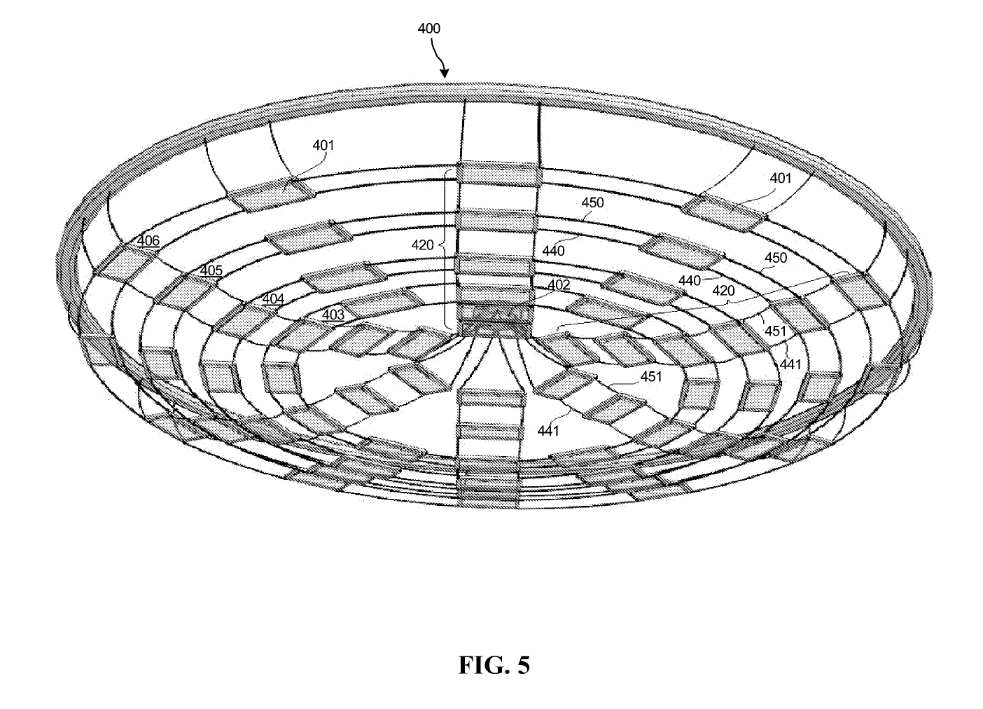

FIG. 6 illustrates an exemplary radial appearance of a plurality of OLED lighting modules together with dangling OLED lighting modules according to an embodiment of the invention. As shown in FIG. 5, the OLED lighting apparatus 500 in accordance with embodiments of the invention can have OLED modules 501 arranged to dangle from a central part 502 that provides power. More specifically, the OLED modules 501 can hang as a string of interconnected panels. A string of panels 501 are suspended in position by first flexible connectors 550 and second flexible connectors 551 from the central part 502. The OLED modules 501 are interconnected by one or more the first flexible connectors 550 and the second flexible connectors 551. Each string of OLED modules 501 can be driven in series through at least one of the first and second flexible connectors 550 and 551 from the central part 502.

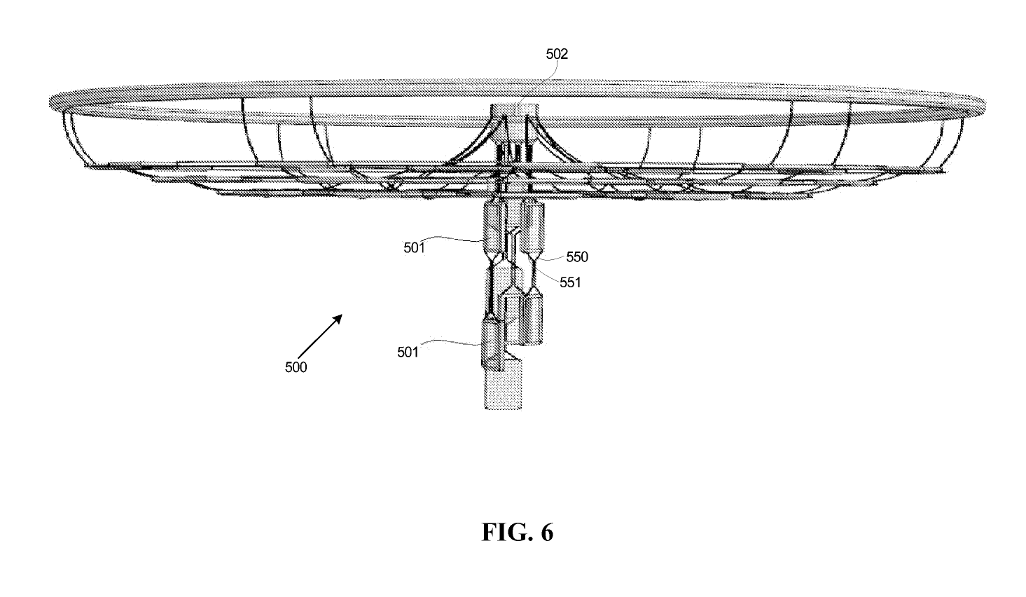

FIG. 7 illustrates an exemplary radial appearance of a first plurality of OLED lighting modules driven in parallel together with a second plurality driven in series. The OLED lighting apparatus 600 shown in FIG. 7 has inner part 400 having the same structure shown in FIG. 5. In addition, FIG. 7 shows OLED lighting modules 601 in strings 620, which receive electric power through the OLED lighting modules of the inner part 400 from the central part 602. Thus, the OLED lighting modules 601 in strings 620 can be controlled separately apart from the OLED modules of the inner part 400.

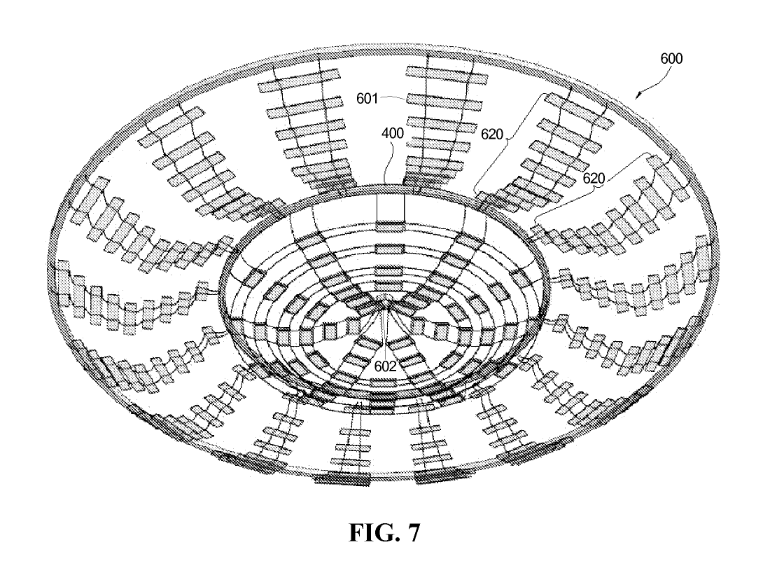

FIG. 8 is a perspective view of a bead LED for attachment to either a serial connector or parallel connector in accordance with embodiments of the invention. All of the OLED lighting apparatuses shown in FIGS. 2 through 7 include OLED lighting modules connected to power part through either serial or parallel connections through one of the first and second connectors. FIG. 8 shows an LED bead 700 drawing power from the plus (+) lead 750a and minus (−) lead 750b of a connector 750 that is bifurcated into two leads as it passes through the bead LED 700. As shown in FIG. 8, the bead LED 700 has only one attached LED 710, but the number of the LEDs 710 can be two or more. Further, more than one bead LED 700 can be used along a connector 750. Other beads 720 that are just decorative can also be positioned along the connector 750.

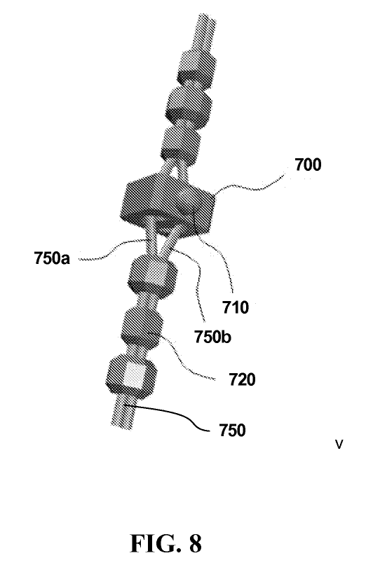

FIG. 9 is a circuit diagram to drive the bead LED terminal in accordance with embodiments of the invention. The LED 710 has a polarity but the polarity of a lead of the connector is not constant or always known. As shown in FIG. 9, if the LED 710 is connected to a full-bridge diode circuit with first and second contacts to the first and second leads of the connector, the LED 710 can be connected regardless of the polarity of the connector leads. As also shown in FIG. 9, the bridge circuit can include resistors R1 and R2 connected series to the LED 710 to limit the current flowing through the LED 710.

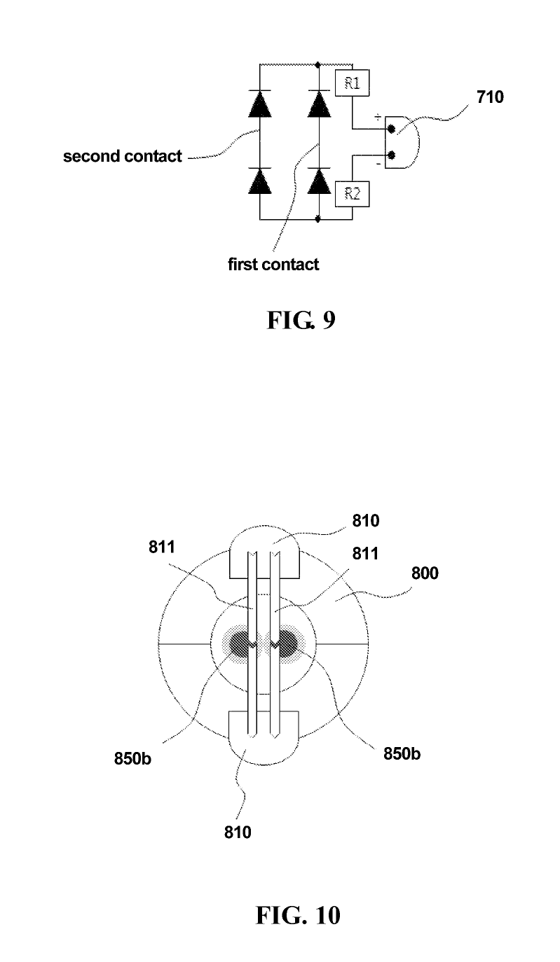

FIG. 10 is a cross-sectional view of the bead LED terminal in accordance with embodiments of the invention. As shown in FIG. 10, a cross-sectional shape of the bead 800 with opposing LEDs 810 can be designed to have a ring shape through which the connector 850 passes through the center. The leads 811 of the LEDs 810 can knife or clamp into the connector 850.

It will be apparent to those skilled in the art that various modifications and variations can be made in the OLED lighting module of embodiments of the invention without departing from the spirit or scope of the invention. Thus, it is intended that embodiments of the invention cover the modifications and variations of this invention provided they come within the scope of the appended claims and their equivalents.

What is claimed is:

1. An OLED lighting module, comprising:
a lighting circuit including:
an OLED light panel;
a first electrode;
a second electrode; and
at least one resistor connected between the OLED light panel and at least one of the first and second electrodes;
first sets of terminals on opposite sides of the module connected to the first and second electrodes; and
second sets of terminals on opposite sides of the module,
wherein the lighting circuit is connected in series between the first sets of terminals.

2. The OLED lighting module in accordance with claim 1, wherein the lighting circuit is connected in series between the second sets of terminals.

3. The OLED lighting module in accordance with claim 1, wherein the second sets of terminals are connected to each other.

4. The OLED lighting module in accordance with claim 1, wherein the resistor is a serial resistor connected between the OLED light panel and at least one of the first and second electrodes.

5. The OLED lighting module in accordance with claim 1, wherein the resistor is a parallel resistor connected across the OLED light panel between the first and second electrodes.

6. The OLED lighting module in accordance with claim 1, further comprising another first set of terminals located on a side of the module other than the opposite sides of the module and another second set of terminals located on the side of the module other than the opposite sides of the module.

7. The OLED lighting module in accordance with claim 1, wherein the OLED light panel is at a front surface of the OLED lighting module and a back surface of the OLED lighting module opposite to the front surface, wherein the front surface is reflective.

8. An OLED lighting module, comprising:
a lighting circuit including:
an OLED light panel;
a first electrode;
a second electrode; and
at least one resistor connected between the OLED light panel and at least one of the first and second electrodes;
first sets of terminals on opposite sides of the module connected to the first and second electrodes; and
second sets of terminals on opposite sides of the module,
wherein the OLED lighting circuit is connected in parallel to the first sets of terminals.

9. The OLED lighting modules in accordance with claim 8, wherein the lighting circuit is connected in parallel to the second sets of terminals.

10. The OLED lighting modules in accordance with claim 8, wherein the second set of terminals is connected to each other.

11. The OLED lighting modules in accordance with claim 8, wherein the resistor is a serial resistor connected between the OLED light panel and at least one of the first and second electrodes.

12. The OLED lighting modules in accordance with claim 8, wherein the resistor is a parallel resistor connected across the OLED light panel between the first and second electrodes.

13. The OLED lighting modules in accordance with claim 8, further comprising another first set of terminals located on a side of the module other than the opposite sides of the module and another second set of terminals located on the side of the module other than the opposite sides of the module.

14. The OLED lighting module in accordance with claim 8, wherein the OLED light panel is at a front surface of the OLED lighting module and the back surface of the OLED lighting module opposite to the front surface, wherein the front surface is reflective.

15. An OLED lighting apparatus, comprising:
first and second OLED lighting modules, each of the first and second OLED lighting modules having a first side, a second side opposite to the first side, a third side and a fourth side opposite to the third side;
a first lighting circuit in the first OLED lighting module;
a second lighting circuit in the second OLED lighting module;
a first set of terminals on the first side of the first OLED lighting module;
a second set of terminals on the first side of the first OLED lighting module;
a third set of terminals on the second side of the second OLED lighting module;
a fourth set of terminals on the second side of the second OLED lighting module;
a first connector attaching the first and third sets of terminals; and
a second connector attaching the second and fourth sets of terminals,
wherein the first connector is a first electrical connection between the first and second lighting circuits.

16. The OLED lighting apparatus in accordance with claim 15, wherein the first electrical connection is a parallel connection.

17. The OLED lighting apparatus in accordance with claim 15, wherein the first and second connectors are flexible.

18. The OLED lighting apparatus in accordance with claim 15, further comprising:
a third OLED lighting module having a first side, a second side opposite to the first side, a third side and a fourth side opposite to the third side;
a third lighting circuit in the third OLED lighting module;
a fifth set of terminals on the third side of the third OLED lighting module;
a sixth set of terminals on the third side of the third OLED lighting module;
a seventh set of terminals on the fourth side of the second OLED lighting module;
an eighth set of terminals on the fourth side of the second OLED lighting module;
a third connector attaching the fifth and seventh sets of terminals; and
a fourth connector attaching the sixth and eighth sets of terminals,
wherein the third connector is a second electrical connection to the third OLED lighting circuit through the second connector.

19. The OLED lighting apparatus in accordance with claim 18, wherein the first electrical connection is a parallel connection and the second electrical connection is a serial connection.

20. The OLED lighting apparatus in accordance with claim 18, wherein each of the first, second and third lighting circuits include:
an OLED light panel;
a first electrode;
a second electrode; and
at least one of a serial and parallel resistor connected between the OLED light panel and at least one of the first and second electrodes.
